(19) United States
(12) Patent Application Publication
(10) Pub. No.: US 2025/0118297 A1
(43) Pub. Date: Apr. 10, 2025

(54) VOICE INTERACTION WITH AI MODELS

(71) Applicant: Mia Labs Inc., Allen, TX (US)

(72) Inventors: Kelvin Quoc Pho, Austin, TX (US); Brian Quoc Hoang, Garland, TX (US); Marwan Kodeih, Dallas, TX (US); Scott Traylor, Carrollton, TX (US)

(21) Appl. No.: 18/906,855

(22) Filed: Oct. 4, 2024

Related U.S. Application Data
(60) Provisional application No. 63/542,609, filed on Oct. 5, 2023.

(51) Int. Cl. G10L 15/183; G10L 13/02; G10L 15/18; G10L 15/30; G10L 19/002; H04M 3/493

(52) U.S. Cl. CPC G10L 15/183; G10L 13/02; G10L 15/1822; G10L 15/30; G10L 19/002; H04M 3/4936; H04M 2201/39; H04M 2201/40

(57) ABSTRACT

This disclosure describes systems, computer readable media, and methods for establishing a user call on a telecommunications network, the call including a user phone number, and establishing a bidirectional communication connection with the user. Audio data is received from the user and sent to a STT service. Text data is received from the STT service, the text data representing the audio data. The AI prompt can be sent to an AI model, from which a text response is received. The text response can be parsed into one or more response statements, which are sent to a TTS service. A stream of speech data can be received from the TTS services and converted to a format suitable for the telecommunications network. A target bitrate for the converted speech can be determined, and the converted speech can be sent to the user at the target bitrate.

### CLAIM OF PRIORITY

This application claims priority under 35 USC § 119 (e) to U.S. Patent Application Ser. No. 63/542,609 filed on Oct. 5, 2023, the entire contents of which are hereby incorporated by reference.

### BACKGROUND

Recent advances in artificial intelligence (AI) such as large language models (LLMs), generative image models and other systems have enabled new applications that were previously impracticable for AI models. In order to better integrate AI models and utilize their capabilities with current systems, solutions can be developed that reduce latency, minimize network traffic, and accommodate legacy data formatting.

### SUMMARY

The present disclosure involves systems, software, and computer implemented methods for enabling low-latency voice communication with an AI model. In some implementations these include receiving a user call from a telecommunications network, the call including a user phone number, and establishing a bidirectional communication connection with the user. Audio data is received from the user and sent to a speech to text (STT) service. Text data is received from the STT service, the text data representing the audio data. A complete statement of the user can be identified from within the text data and used to generate an AI prompt. The AI prompt can be sent to an AI model, from which a text response is received. The text response can be parsed into one or more response statements, which are sent to a text to speech (TTS) service. A stream of speech data can be received from the TTS services and converted to a format suitable for the telecommunications network. A target bitrate for the converted speech can be determined, and the converted speech can be sent to the user at the target bitrate.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings, in which like reference numbers indicate similar elements.

FIG. 1 is a schematic diagram of a system for enabling voice interaction with AI models.

FIG. 2 is a flowchart illustrating an example process for voice interaction with an AI model.

FIG. 3 is a flowchart illustrating an example process for voice interaction with an AI model.

FIG. 4 is a flowchart showing an example process for voice interaction with an AI model.

FIG. 5 is a block diagram illustrating an example of a computer-implemented system.

### DETAILED DESCRIPTION

This disclosure describes methods, software, and systems for enabling voice communication with one or more AI models. In general, a user can place a phone or voice call to an AI conversation system, which will manage formatting and data conversion in order to enable a natural, intuitive conversation between the telephone or voice user and the AI model.

The AI conversation system, which can be a backend system such as a server or web based system, acts as an intermediary between a voice user and an AI model. For example, the AI conversation system functions by converting voice into text, performing an analysis of the text to generate a suitable AI prompt, sending the prompt to an AI model to receive a model response, then parsing the model response and delivering it as speech back to the voice user. This conversation mediation is performed in a manner that reduces latency between the voice user and the AI model using streaming technology to send data in smaller packages. Further the voice user retains the ability to interrupt and redirect the process at any moment simply by speaking, because the AI conversation system intelligently throttles audio packets sent to the user's devices such that the stream of speech being sent can be stopped with little or no delay.

The described solution is advantageous in that it enables a user to intuitively speak to an AI model, including interrupting the model if redirection or a different request is necessary without waiting for the model to complete relaying its output. The AI conversation system employs multiple techniques to manage latency enabling a natural conversational pace between the user and the AI model. Further, the AI conversation system enables highly customizable behavior for the AI model by providing background or contextual prompting, enabling different experiences for different users or different services. Another advantage of the disclosed solution is that prompts and traffic between the AI conversation system can be reduced by utilizing additional systems. For example, if the AI conversation system is able to provide a suitable response without prompting the AI model, or by prompting a non-AI model source (e.g., a third party database), the AI conversation system can do so. Another advantage of the disclosed system is that it can perform external function calls requested by the AI model to retrieve relevant facts or structured data, then provide that to the AI model. This reduces the risk of one major shortcoming of many AI models, the tendency to provide erroneous factual information.

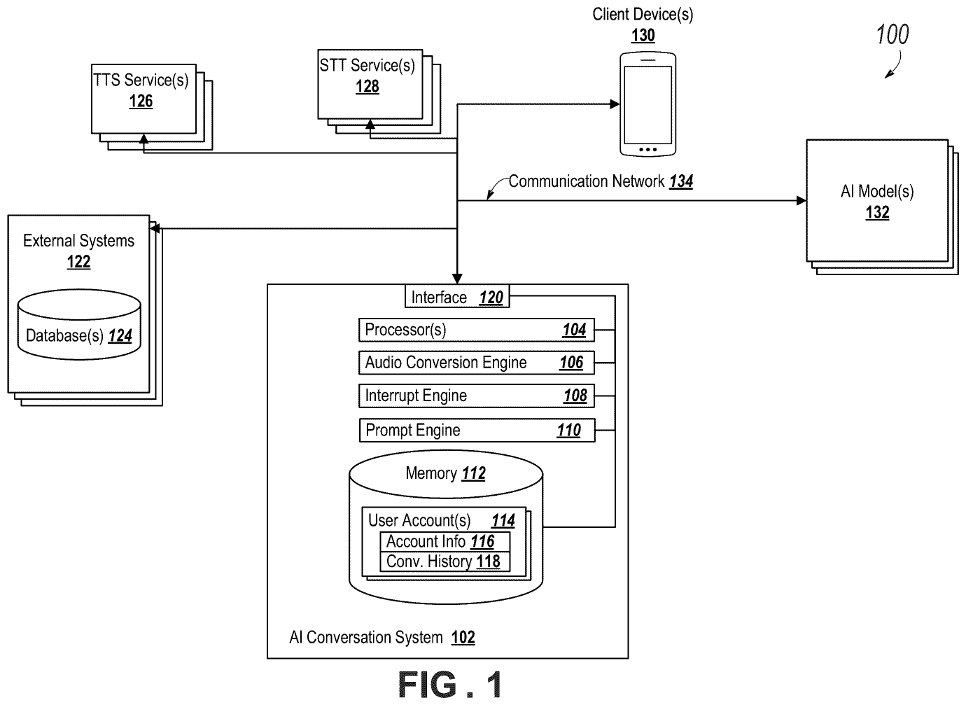

FIG. 1 is a schematic diagram of a system 100 for enabling voice interaction with AI models. FIG. 1 illustrates an AI conversation system 102 that communicates with external systems 122, Text-to-Speech (TTS) services(s) 126, Speech-to-Text (STT) service(s) 128, one or more client devices 130, and one or more AI models 132. The AI conversation system 102 communicates via one or more communication networks 134.

Communication networks 134 facilitate wireless or wireline communications between the components of the system 100 (e.g., between the AI conversation system 102, the client device(s) 130, the AI models 132, and the external systems 122 etc.), as well as with any other local or remote computers, such as additional mobile devices, clients, servers, or other devices communicably coupled to communications network 134, including those not illustrated in FIG. 1. In the illustrated environment, the network 134 is depicted as a single network, but can comprise more than one network without departing from the scope of this disclosure, so long as at least a portion of the network 134 can facilitate communications between senders and recipients. In some instances, one or more of the illustrated components (e.g., AI models 132, STT services 128, etc.) can be implemented as one or more cloud-based services or operations. The network 134 can be all or a portion of an enterprise or secured network, while in another instance, at least a portion of the network 134 can represent a connection to the Internet. In some instances, a portion of the network 134 can be a virtual private network (VPN). Further, all or a portion of the network 134 can comprise either a wireline or wireless link. Example wireless links can include 802.11a/b/g/n/ac, 802.20, WiMax, LTE, and/or any other appropriate wireless link. In other words, the network 134 encompasses any internal or external network, networks, sub-network, or combination thereof operable to facilitate communications between various computing components inside and outside the illustrated system 100. The network 134 can communicate, for example, Internet Protocol (IP) packets, Frame Relay frames, Asynchronous Transfer Mode (ATM) cells, voice, video, data, and other suitable information between network addresses. The network 134 can also include one or more local area networks (LANs), radio access networks (RANs), metropolitan area networks (MANs), wide area networks (WANs), all or a portion of the Internet, and/or any other communication system or systems at one or more locations.

AI conversation system 102 includes an audio conversion engine 106, interrupt engine 108, and prompt engine 110, which can execute on one or more processors 104 and access information stored within memory 112 as well as other places. The audio conversion engine 106, interrupt engine 108, and prompt engine 110, can be provided as one or more computer executable software modules, hardware modules, or a combination thereof. For example, these components can be implemented as blocks of software code with instructions that cause one or more processors 104 to execute operations described herein. In addition, or alternatively, one or more of these components can be implemented in electronic circuitry such as, e.g., programmable logic circuits, field programmable logic arrays (FPGA), or application specific integrated circuits (ASIC).

Although illustrated as a single processor 104 in FIG. 1, multiple processors can be used according to particular needs, desires, or particular implementations of the system 100. Each processor 104 can be a central processing unit (CPU), an application specific integrated circuit (ASIC), a field-programmable gate array (FPGA), or another suitable component. Generally, the processor 104 executes instructions and manipulates data to perform the operations of the AI conversation system 102. Specifically, the processor 104 executes the algorithms and operations described in the illustrated figures, as well as the various software modules and functionality, including the functionality for sending communications to and receiving transmissions from client devices 130, AI models 132, as well as to other devices and systems. Each processor 104 can have a single or multiple cores, with each core available to host and execute an individual processing thread. Further, the number of, types of, and particular processors 104 used to execute the operations described herein can be dynamically determined based on a number of requests, interactions, and operations associated with the AI conversation system 102.

Audio conversion engine 106 converts data between multiple formats for interaction between client devices 130, the AI conversation system 102, and various AI models 132. For example, voice data may be received in a telephonic format such as a pulse code modulation (PCM) signal encoding audio data at an 8 Khz sample rate, with each sample having 8 bits, giving a 64 kbit per second data rate. The audio conversion engine 106 can convert the PCM signal into an MP3 format or other format suitable for processing by other systems. Further, the audio conversion engine 106 can receive a stream of MP3 or other audio data and convert it to a PCM signal.

The audio conversion engine 106 can handle conversion of audio data to and from text data as well. The audio conversion engine 106 can use one or more external services such as TTS services 126 or STT services 128 to convert audio/speech to and from text. The STT services 128 can be accessed using an API and can be, for example, Deepgram, Amberscript, Rev, Google Cloud STT, AssemblyAI, Scriptix, OpenAI, or other suitable STT service.

In some implementations, the STT service 128 provides both interim results, and endpoint results, the interim results offering a low latency preliminary transcript that generates text at real-time or near real-time from a stream of audio. Endpoint results can consider larger portions of the audio stream (e.g., full sentences or phrases) to provide a more accurate transcription. In some implementations the endpoint results include punctuation, which the audio conversion engine 106 can use to parse complete thoughts or phrases from received voice data. In addition to using punctuation, the audio conversion engine 106 can identify complete thoughts based on timing information (e.g., pauses in the stream of text) or semantic analysis of the interim results.

In addition to being used for follow-on analysis, interim results from the STT service 128 can be used to enable interruptions during a “listening” phase of the AI conversation system 102 as discussed in more detail below with respect to the interrupt engine 108. The endpoint results from STT service 128 can be sent to the prompt engine 110 for further processing and analysis as discussed in more detail below.

In some implementations the STT service 128 can perform speaker diarization on received audio data. This can allow the audio conversion engine 106 to identify the user based on past conversations or a particular prompt, and then filter out unwanted speech. For example, if a user is communicating using a speaker phone, with others talking in the background, a diarization function can be used to reject or filter the non-user speech in the audio file.

The TTS service 126 can be used by the audio conversion engine 106 for converting text information into audio/speech data. In some implementations, the TTS service 126 receives text from the audio conversion engine and returns a stream of mp3 (or other) encoded bytes that represent audio speech of the received text. The audio conversion engine 106 can then convert that stream to a format suitable for a telephone service (e.g., PCM) and send it to the interrupt engine 108 for transmission to a client device 108. In some implementations, the TTS service 126 performs word by word streaming, that is, it returns audio data for each word received in near real time. In some implementations, the TTS service 126 performs sentence conversion, or phrase conversion, where it considers larger portions of received text before delivering audio encoded response.

In some implementations, prior to sending the output to the TTS service, a text optimization process can be performed on it. During text optimization, certain abbreviation can be replaced, and numbers be explicitly spelled out in order to avoid ambiguity or confusing speech results.

While the TTS service 126 and the STT service 128 are illustrated as separate systems in FIG. 1, in some implementations they are incorporated into the AI conversation system 102. In other words, TTS, STT, or both can be locally performed by the AI conversation system 102. Additionally, while illustrated as different components, the STT service 128 and TTS service 126 can be provided by the same system or systems.

In some implementations, the audio conversion engine 106 can receive output text from the AI models 132, convert some of it to speech, and leave some as text. For example, a response can include a hyperlink to a web URL. The audio conversion engine can convert some of that output to speech and send the speech to the client device 130, then additionally transmit a text or SMS message with the hyperlink to the client device 130.

The AI conversation system 102 communicates with various components within system 100 using interface 120. Generally, the interface 120 comprises logic encoded in software and/or hardware in a suitable combination and operable to communicate with the network 134 and other components. More specifically, the interface 104 can comprise software supporting one or more communication protocols associated with communications such that the network 134 and/or interface's 120 hardware is operable to communicate physical signals within and outside of the illustrated system 100. Still further, the interface 120 can allow the AI conversation system 102 to communicate with the client devices 130, external systems 122, and/or other portions illustrated within the system 100 to perform the operations described herein.

The interrupt engine 108 is provided to enable a voice user operating the client device 130 to interrupt the AI conversation system 102 and redirect it naturally, e.g., similarly to what could happen during a voice conversation between two humans. In general, during a conversation, the AI conversation system 102 can be thought to be either “listening” or “speaking” at any given time. Additionally, or in parallel the AI conversation system 102 can be “thinking” during both “listening” and “speaking” operations. The interrupt engine 108 can provide interrupts during both “listening” and “speaking.”

During listening operations, the interrupt engine 108 continues to monitor incoming text from the STT service 128, and if additional interim results are detected indicating that the user had not completed their thought, or had additional concepts to add after a complete thought was identified by the audio conversion engine 106, then the interrupt engine 108 can stop any prompt generation occurring at the prompt engine 110, and reset the “thinking” processes of AI conversation system 102 in order to process the additional speech that is incoming.

During speaking operations, the interrupt engine 108 analyzes the audio stream coming from the TTS service 126 and determines an amount of throttling to apply to the outgoing speech data that was converted by the audio conversion engine 106. In general, the interrupt engine 108 can limit the bitrate of outgoing speech data (e.g., throttle) in order to ensure that the outgoing data rate is approximately equal to the rate at which the client device 130 will play the audio. This ensures there is not a large buffer of un-played audio stored at the client device 130 in the event the user attempts to interrupt.

In operation, if the AI conversation system 102 is speaking, the interrupt engine 108 is transmitting throttled speech data that was converted from the audio conversion engine 106 to the client device 130. Should the user of the client device 130 begin speaking, the STT service 128 can begin returning interim results which can be detected by interrupt engine 108. Upon detection of the interim results, the interrupt engine 108 can cease sending speech data, which, because a minimal amount of extra data was sent to the client device 130, will rapidly stop the AI conversation system 102 from speaking.

The amount of throttling to apply to the speech data can be determined based on a network latency. In some implementations, the throttling to be applied for a given transmission of audio data based on the equation Lₙ=(Dₙ−Dₙ₋₁)−Tₙ₋₁, where Lₙ represents the current latency, Dₙ represents the current time, Dₙ₋₁ represents the time of the previous transmission, and Tₙ₋₁ represents the throttle delay from the previous transmission. Once this latency is calculated, the throttling for an upcoming transmission can be calculated using the equation Tₙ=M−Lₙ, where M represents a maximum allowable throttle value. This dynamic throttling is particularly useful during initial audio transmission from a queue. During playback, the AI conversational system 102 can concurrently retrieve bytes for the succeeding audio segment. These subsequent audio segments can then have a more constant throttling value, which ensures seamless audio delivery to the client device 130.

The audio conversion engine 106 can simultaneously be listening to the audio data coming from the client device 130 and send endpoint results and interim results to the prompt engine 110 for further analysis and an updated prompt/response.

Prompt engine 110 receives text data from the audio conversion engine 106 and/or the STT service 128 and performs an analysis in order to generate a prompt and invoke one or more AI models 132 in order to generate an output that it can pass back to the audio conversion engine.

In some implementations, the prompt engine 110 can generate or handle three general categories of prompts: system prompts, user prompts, and function prompts. System prompts provide context and direction to the AI model 132 and provide for additional communication between the AI conversation system 102 and the AI model 132. User prompts relay information or queries from the user via the client device 130 to the AI model 132 in order to generate an output response to provide back to the client device 130. Function prompts enable the AI model 132 to call functions within the AI conversation system 102 to obtain structured data for the AI model 132 to use in generating a response.

In some implementations, the prompt engine 110 generates and sends an initialization prompt to the AI models 132 during initialization of a call between client device 130 and ai conversation system 102. An initialization prompt is a type of system prompt that can provide the AI model 130 with initial context and direction of how to answer upcoming prompts sent by the user. Additionally, an initialization prompt may include previous conversation history. For example, each unique user operating a client device 130 can have a user account 114 generated and stored in a memory 112. The user accounts 114 can each include certain account information 116, which can have, for example, phone number, name, address, or other information associated with the user, and a conversation history 118. The conversation history 118 can include past prompts and responses, as well as transcripts of previous user speaking. An example initialization prompt for an AI conversation system 102 configured to assist with a car dealership may be as follows:
Today's date is $ {getFormattedDate ( )}. As $ {AI.Name}, you're answering the phone as a vibrant business development rep from $ {org.name}. Aim for short and snappy responses (under 30 words) with a friendly demeanor. A sprinkle of humor is welcome! Ditch the overly formal vibes. Your main mission? Getting the customer to pencil in an appointment or test drive during our operating hours.
Quick rundown of our business: $ {org.description}
Our doors are open from: $ {org.hours}
If the conversation already covered specific vehicle details, cut to the chase. For example, when asked about the mileage of a car we've touched on, simply reply ‘It's clocked 50,000 miles.’ instead of the verbose ‘The 2008 Honda Civic has covered 50,000 miles.’
Looking up inventory details? Be sure to use functions, rather than saying you're checking the inventory.
Imagine you're on a call with the customer. Spell out the specifics. Say ‘28 city and 36 highway miles per gallon’ instead of ‘28/36 mpg.’ Got intricate details? Propose sending a text for clarity.
Offering a link? It's better to suggest texting it over than reading out a URL. So, something like, ‘How about I shoot over a link via text?’
If financing pops up, give them a ballpark figure for their potential payments. Disclaim that it's an estimate and that they'll need to come in for a more accurate quote.
Your North Star? Getting them to commit to an appointment or test drive. A nudge like ‘Need any more info before we slot in your appointment to view {the/a} vehicle?’ should do the trick. To seal the deal, just verbally confirm a date and time during our business hours.
You will use the below context from the $ {org.name} website to help answer questions specific to the business. Such as the location/address, parking situation, etc. \nn ###INFORMATION

Additional system prompts during the conversation can occur, for example to define the available function calls to the AI model 130, revise the attitude or personality of the AI model 130, provide feedback on the AI model's 130 performance or otherwise modify the behavior of the AI model 130.

User prompts are generated by the prompt engine 110 in response to text data that is received from the STT service 128 or audio conversion engine 106. In general, user prompts include the text information and tokens associated with the previous prompts/responses in the conversation. Each user prompt can be sent with one or more system prompts or function prompts. As the conversation continues, each new user prompt is appended to the previous prompts, providing the AI model 132 with the full context of the conversation each time. In some implementations, previous user prompts are tokenized or embedded, or otherwise compressed in order to reduce the length of the user prompt.

In some implementations, semantic analysis or other natural language processing can be performed by the AI conversation system 102, or prompt engine 110 prior to prompt generation. The semantic analysis can identify function calls, certain data repositories that may be required, or other elements of the conversation. In some implementations, semantic analysis can identify a request for information to which the AI conversation system 102 can provide a direct response or pre-developed answer. For example, if the user asks a complex question, a semantic analysis of the question can determine that the AI model 132 will take some time to respond and provide a rapid initial response of “hang on, let me check” or similar.

In some implementations, the received text can be translated by the prompt engine 110, in enabling the AI conversation system 102 to receive inputs in one language, and convert them to a language to which the AI model 132 being used is more capable. Similarly, the output of the AI model 132 can be translated back to the origin language (or to another language) prior to being sent to the TTS service 126.

Function prompts enable the AI model 132 to request and receive structured data from the AI conversation system 102. For example, a user may query the inventory for a particular product from a particular set of product dealers. Upon receipt of an initial user prompt containing the request, the AI model 132 may determine it needs access to that particular data and respond with a function call to the AI conversation system 102. The AI conversation system 102 can perform the function, which may include querying one or more external systems' 122 databases 124 to collect the requested data, then return the data in a predetermined structured format to the AI model using a function prompt. This enhances the accuracy of the AI model 132, which may be prone to fabricating facts if it is unable to query them.

In some implementations, the prompt engine 110 can select between multiple AI models 132. For example, based on latency, costs, network traffic, or the user query itself (as identified by natural language processing or semantic analysis). The prompt engine 110 can select between, e.g., GPT-4, GPT-3.5, Perplexity AI, Google Bard, Claude, etc. In some implementations, the prompt engine 110 can select the AI model 132 to use based on a semantic analysis of the incoming speech. For example, if the incoming speech is a query that involves performing mathematical calculations, GPT-4 may be preferred over GPT-3.5. In another example, where low latency/response time is desirable and the query is relatively simple, the prompt engine 110 may select Google Bard.

In some implementations, once a particular AI model 132 is selected, the prompt can be generated or modified to better suit that particular model. For example, if a model is selected that permits higher input token counts, more detail or specificity can be added to the prompt.

After a prompt is sent to the AI Model 132, a text output is sent from the AI model 132 to the AI conversation system 102. The prompt engine 110 receives a streaming output from the AI model 132 and can break it into smaller portions (e.g., phrases, sentences etc.) to send to the audio conversion engine for conversion to speech, then PCM formatting, then to the client device 130. By sending smaller portions, unnecessary delay in the conversation by the AI conversation system 102 is minimized, as the audio conversion engine 106 can begin converting and transmitting the initial response while the AI model 132 is still providing output to the prompt engine 110.

Memory 112 of the AI conversation system 102 can represent a single memory or multiple memories. The memory 112 can include any memory or database module and can take the form of volatile or non-volatile memory including, without limitation, magnetic media, optical media, random access memory (RAM), read-only memory (ROM), removable media, or any other suitable local or remote memory component. The memory 112 can store various objects or data, including digital asset data, public keys, user and/or account information, administrative settings, password information, caches, applications, backup data, repositories storing business and/or dynamic information, and any other appropriate information associated with the asset management system 102, including any parameters, variables, algorithms, instructions, rules, constraints, or references thereto. Additionally, the memory 112 can store any other appropriate data, such as VPN applications, firmware logs and policies, firewall policies, a security or access log, print or other reporting files, as well as others. While illustrated within the AI conversation system 102, memory 112 or any portion thereof, including some or all of the particular illustrated components, can be located remote from the AI conversation system 102 in some instances, including as a cloud application or repository or as a separate cloud application or repository when the AI conversation system 102 itself is a cloud-based system. In some instances, some or all of memory 112 can be located in, associated with, or available through one or more other systems of the associated enterprise software platform. In those examples, the data stored in memory 112 can be accessible, for example, via one of the described applications or systems. As illustrated and previously described, memory 112 includes a database of user accounts 114.

In some implementations the AI conversation system 102 can include a dashboard or other user interface that allows users to directly access (e.g., log into) the AI conversation system 102 and view or edit their user account 114. The dashboard may enable a user to modify past prompts and receive new outputs or response, as well as provide feedback and more information for future training or product improvement.

AI Models 132 can include a combination of machine learning algorithms, neural network, and/or large language models. A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code. For brevity, large language models are also referred to herein as “language models.”

The language model can be any appropriate language model neural network that receives an input sequence made up of text tokens selected from a vocabulary and auto-regressively generates an output sequence made up of text tokens from the vocabulary. For example, the language model can be a Transformer-based language model neural network or a recurrent neural network-based language model.

In some situations, the language model can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model can process the current input sequence to generate a score distribution (e.g., a probability distribution) that assigns a respective score, e.g., a respective probability, to each token in the vocabulary of tokens. The neural network of the language model can then select, as the particular token, a token from the vocabulary using the score distribution. For example, the neural network of the language model can greedily select the highest-scoring token or can sample, e.g., using nucleus sampling or another sampling technique, a token from the distribution.

As a particular example, the language model can be an auto-regressive Transformer-based neural network that includes (i) a plurality of attention blocks that each apply a self-attention operation and (ii) an output subnetwork that processes an output of the last attention block to generate the score distribution.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the AI conversation system 102 can use the same language model to generate multiple different candidate output sequences in response to the same request, e.g., by using beam search decoding from score distributions generated by the language model, using a Sample-and-Rank decoding strategy, by using different random seeds for the pseudo-random number generator that's used in sampling for different runs through the language model or using another decoding strategy that leverages the auto-regressive nature of the language model.

In some implementations, the language model is pre-trained, i.e., trained on a language modeling task that does not require providing evidence in response to user questions, and the AI conversation system 102 (e.g., using prompt engine 110) causes the language model to generate output sequences according to the predetermined syntax through natural language prompts in the input sequence.

In some implementations, the AI conversation system 102 can generate a prompt that is submitted to the language model (e.g., one of the AI models 132), and causes the language model to generate output sequences, also referred to as passages or simply as “output”. The prompt engine 110 can generate the prompt in a manner (e.g., having a structure) that identifies a list of one or more online sources of information, such as a list of one or more websites or data repositories, and specifying a set of constraints the language model must use to generate the output using the prompt. In some implementations, prompt includes one or more HTML web pages, or a consolidation of extracted data from one or more web pages.

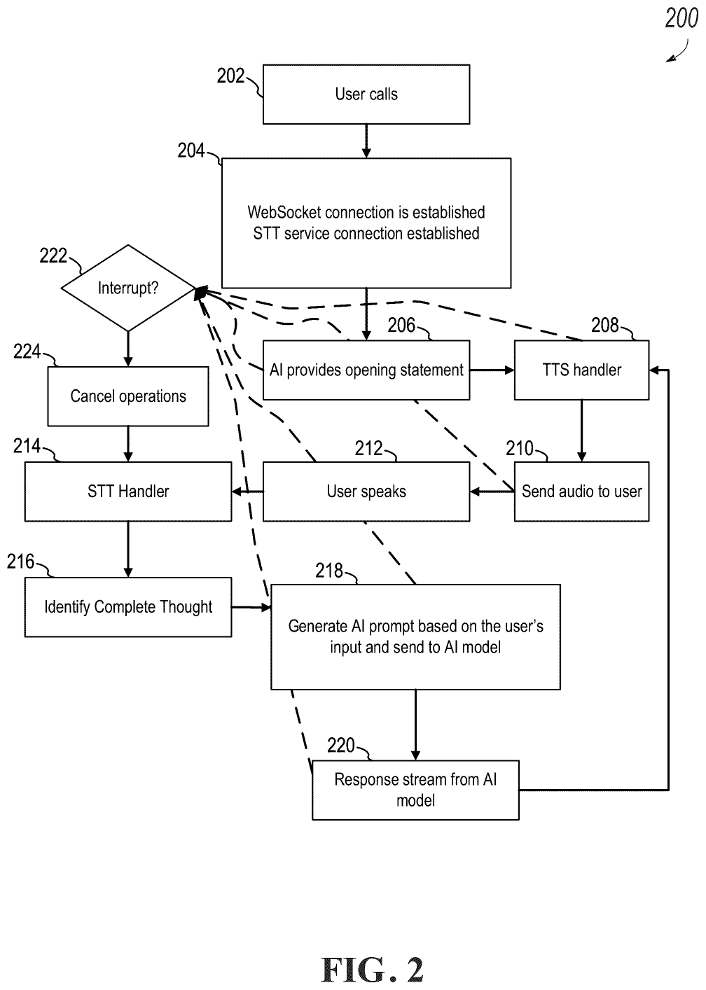

FIG. 2 is a flowchart illustrating an example process 200 for voice interaction with an AI model. Process 200 enables use of a conversational AI system, designed to revolutionize how businesses interact with their users. While phone communication stands as a pivotal component of the system, it's just one facet of its multifaceted communication capabilities, which also encompass texting, emailing, and online chatting. Process 200 is an example of how an AI conversation system (e.g., AI conversation system 102 of FIG. 1) handles phone calls, showcasing the seamless integration of real-time bidirectional communication, dynamic prompt generation, and advanced data processing techniques. These combined elements not only ensure fluid and personalized interactions over the phone but also highlight the system's scalability and adaptability, making it a versatile solution suitable for diverse industries and communication channels.

At 202 a user calls into the system, and a WebSocket connection is established, as well as the STT service connection is established (204). Upon initiation of a call to the AI conversational system phone number, a WebSocket connection is established. This WebSocket acts as the primary bidirectional communication channel, facilitating the real-time media stream transmission from the calling user and the subsequent audio data relay from the AI conversational system.

Immediately upon the establishment of this WebSocket connection, pertinent data is extracted, including but not limited to the caller's phone number. This data extraction process enables the determination of prior interactions, if any, with the caller. Subsequent data points, such as the caller's name, caller's full legal name, product preferences, geographical location, physical address, email address, can be derived or requested.

Concurrently with the initiation, the AI conversational system initiates communication with the caller through a predefined response (206), addressing the legal prerequisites associated with call recording. The opening statement and response mechanism is a hybrid of predetermined responses and adaptive natural language processing (NLP) logic. Alternative NLP approaches include TF-ID F, semantic analysis, finite-state machines, embeddings, semantic parsing, and retrieval-based models. This dual approach is employed based on the anticipated user input. For instance, in scenarios where a user's name is expected after the AI conversational system's prompt, our NLP logic is engaged to detect the presence of a name within the user's response. Subsequently, a tailored canned response is generated, incorporating the detected name (e.g., “Hello, $ {caller's name}. How may I assist you today?”).

This methodology is consistently applied in various interaction scenarios, particularly when executing specific actions like sending text messages or concluding the call. In such instances, user responses typically align with affirmative or negative acknowledgments, such as “yes” or “no”. The detailed mechanics of these actions and their corresponding responses are elaborated upon in the subsequent sections. In general, when a statement is to be sent to the user, text is sent to a text-to-speech (TTS) service (208), which provides audio data that can be converted into a u-law format and sent to the user (210).

Upon the successful establishment of the WebSocket connection, an immediate linkage to a low-latency speech-to-text (STT) service is initiated. The incoming audio data via the WebSocket is presented as an encoded payload, which is subsequently transformed into a Buffer. Given that the audio data from telephonic sources is frequently encoded using the “u-law” format with a specific sample rate, an STT solution specifically tailored for transcribing telephonic audio data can be employed.

During the transcription process (212), both interim and conclusive results are tracked. The interim results, while offering the advantage of reduced latency, may compromise on accuracy. These preliminary transcriptions are useful, however, for facilitating interruptions and rapidly approximating user utterances. Upon receipt of the final transcription from the STT service (214), a comprehensive analysis is conducted to ascertain the completeness of the user's statement (216). By amalgamating our NLP logic with the inherent functionalities of the STT service, the system can discern the conclusion of a user's thought, primarily through the detection of terminal punctuation. Only transcriptions that align with this specific criterion are relayed to a large language model (LLM) to elicit an appropriate response. It's noteworthy that this mechanism, while highly efficient, may not guarantee absolute accuracy. Instances where a user articulates a complete thought, momentarily pauses, and then resumes necessitate the integration of a sophisticated interruption system, as discussed in more detail below.

Once a complete thought is identified, and converted to text using the STT handler, an AI prompt can be generated based on the user's input (218). Prompts constitute an important component in the AI conversation system's decision-making process regarding user responses. For every request dispatched to the LLM, a fresh prompt is generated. The prompt's structure can be delineated as follows:

System Prompts: These prompts guide the AI conversation system's behavior, furnishing it with business-specific details and real-time data. For instance, the current day and time, adjusted to the business's time zone, are computed and relayed to the AI conversation system as a business prompt. Additionally, customers, which can be businesses or other entities, have the flexibility to embed custom prompts, encompassing details like their address, operational hours, regulations, and other nuanced information not necessarily available on their website or on the internet, such as parking logistics.

User/Assistant Prompts: These prompts encapsulate the ongoing dialogue between the caller (user) and the AI conversation system (assistant). To ensure the AI conversation system retains contextual awareness of the conversation, this segment of the prompt undergoes updates with every subsequent user interaction.

Function: Functions serve as conduits for specific LLMs to execute calls and relay structured data back to the AI conversation system, like a JSON response. This capability facilitates the invocation of pre-existing functionalities based on the structured data from the LLM. Such functionalities are predominantly employed for integrations, like querying a specific item in a customer's inventory, or for specific actions, such as messaging the user or redirecting them to a human representative.

As previously highlighted, prompts are regenerated each time output tokens are required, predominantly when a user's query or statement necessitates a response. Depending on the nature of the user's query, be it a rudimentary inquiry (e.g., “What is your return policy?”) or a more intricate request necessitating an integration (e.g., “I'm seeking a sporty car with less than 30k miles”), the prompt generation approach might vary. The overarching objective remains consistent: to extract and incorporate the user's desired information into the prompt, enabling the LLM to produce relevant output tokens.

For user queries that demand integration utilization, the LLM activates a function call. This call subsequently fetches data from the pertinent integration system, such as an inventory management system. Utilizing techniques like embeddings or fuzzy search, the retrieved information is then relayed back to the LLM as a prompt. This format ensures easy interpretation and augments the likelihood of generating precise tokens. In scenarios where the LLM doesn't initiate a function call, context is derived from data scraped from the client's (business) website. In addition to deriving context from the client's website, other forms of media can be used. For example, the context can be scraped from client social media, publications, news stories, third party analysis services, and other sources.

The prompt generation infrastructure is architecturally designed for adaptability across diverse industries. Moreover, it operates independently of the core call process, ensuring scalability and compatibility with adjacent markets.

Once a prompt is sent to an LLM, a response stream from the AI model is received (220). Data from the LLM is typically relayed as a stream, although alternative solutions are possible. Instead of waiting for the complete generation of output tokens, each token is received almost immediately after its creation. To illustrate, for a statement like “Hello, it's nice to meet you”, each word is streamed to us sequentially rather than delivering the entire sentence in one go. This approach significantly diminishes latency, as the response is processed word-by-word not necessitating awaiting the full statement.

Tokens are concatenated until specific punctuation marks are encountered. Delimiters such as commas, periods, and question marks often signify a pause in the response. Recognizing these pauses allows segmentation of the incoming response and expediting its relay to the TTS handler (208), as opposed to transmitting the complete statement. This segmentation significantly reduces latency.

This statement separation system can discern appropriate segmentation points. In some implementations, the statement separation system can be configured to overlook punctuation within numerical values, ensuring that decimal points or commas within numbers (e.g., 17.5 or 43,000) are not misconstrued as segmentation cues. This can be performed, for example, by an audio conversion engine such as audio conversion engine 106 of FIG. 1. Prior to dispatching the text to the TTS handler, modifications can be implemented to enhance clarity. Specific terms and industry jargon can be expanded to ensure comprehensibility. For instance, abbreviations like “390 hp” are transformed to “390 Horsepower”, and “A/T” is rendered as “Automatic Transmission”. Furthermore, the system conducts a scan of the output tokens to identify the presence of any functions. Upon detection, the corresponding integration can be invoked without delay.

The TTS handler (208) can provide for one mode for the AI conversational system to interact with the user. Other modes can include text messaging, email, etc. During textual content vocalization the AI conversation system is directly instructed to vocalize specific textual content. Sequential statements can be provided, allowing for continuous streaming of responses, especially when integrating with large language models (LLMs). For instance, instructing the system to vocalize, “Hey, this is your AI for <Business Name>” followed by “Who do I have the pleasure of speaking with?” ensures that the AI conversation system sequentially vocalizes both statements. To prevent audio overlap or sequence disruption, a multi-tiered queuing system is employed. The initial queue prepares audio bytes from the text-to-speech (TTS) service, ensuring readiness for playback. Subsequently, the audio is queued in the intended playback sequence.

Upon obtaining the audio data for playback, it is segmented into data chunks, with a controlled transmission rate. Further details on this process are discussed below with regard to the interrupt (222). Incoming audio data undergoes conversion to the PCM-law audio codec, characterized by a specific sample rate, linear PCM output format, and a singular audio channel. This conversion ensures telephonic compatibility and prevents audio distortion. The system's flexibility allows for the conversion of a myriad of audio formats, accommodating various TTS services. In some implementations, to ascertain the completion of audio playback, the system does not solely rely on the receipt of all audio bytes. Instead, it calculates the playback duration using: Total bytes of audio/sample rate (kHz). In such implementations, only after this calculated duration does the system recognize the audio clip's completion, proceeding to the subsequent clip in the queue.

During any of operations 206, 208, 210, 218, or 220 the user can begin speaking again and interrupt the process (222). Adept handling of interruptions enables a fluid and natural conversation. A distinctive feature of the AI conversation system is its capability to process interruptions almost instantaneously. Should a user interject while the AI conversation system is vocalizing, the AI conversation system promptly halts its speech to attentively listen to the user. Interruptions can manifest at diverse junctures, including but not limited to, post LLM request submission, during LLM output token generation, amidst prompt creation, or while audio is being relayed. To maintain coherence, every finalized user transcription is allocated a unique response ID, facilitating the tracking of the AI conversation system's corresponding response through its various stages.

Interrupting the process during output token generation is relatively straightforward. Given that output tokens are streamed, any detected interruption during this stream immediately terminates the stream, and subsequent operations, such as audio queuing and playback, are immediately aborted.

However, it is more complex to interrupt the AI conversation system during vocalization. Considering the rapid reception of audio bytes from the TTS service compared to their playback rate, prematurely terminating the audio stream poses challenges. This is primarily due to the fact that the audio data might have already been dispatched to the client, at which point the client device cannot be stopped from playback. To circumvent this, a dynamic throttling mechanism that modulates the transmission rate of audio data to the client/user is implemented. This ensures that the data flow aligns closely with real-time audio playback. Dynamic throttling is particularly useful for the initial audio in the queue. While this audio is in playback, the system is concurrently retrieving bytes for the succeeding audio segment. For these subsequent audio segments, a more consistent throttling value can be applied, ensuring seamless audio delivery.

Once an interrupt is identified, operations at the AI conversation system are canceled (224) and process 200 proceeds to 214 where the user's speech is interpreted.

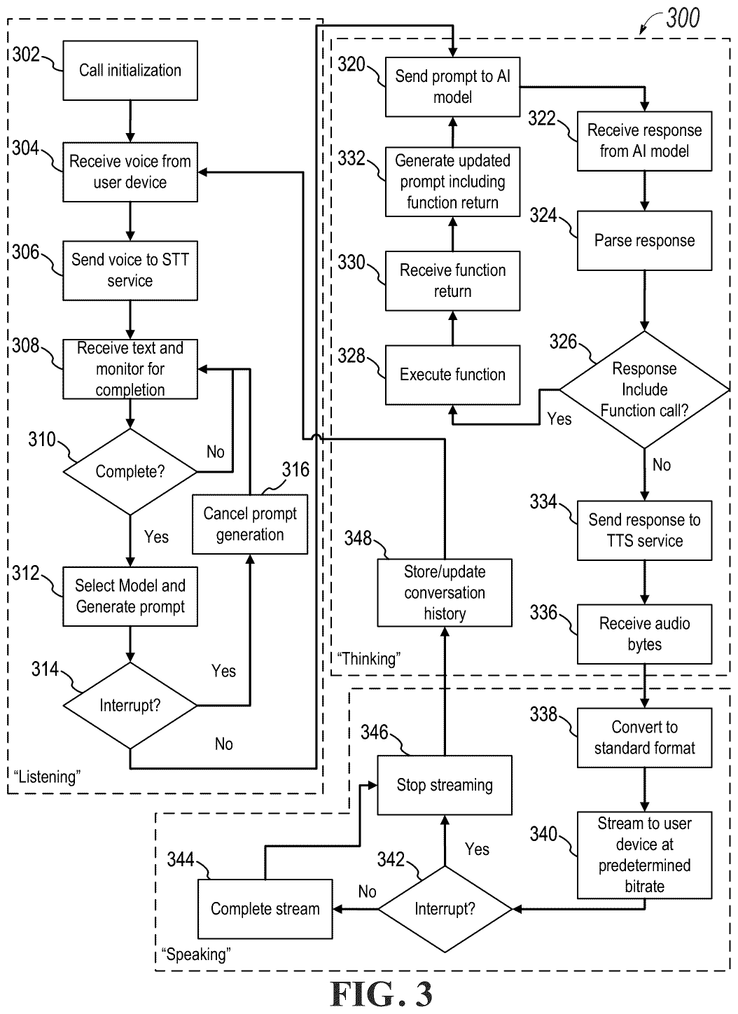

FIG. 3 is a flowchart illustrating an example process for voice interaction with an AI model. It will be understood that process 300 and related methods may be performed, for example, by any suitable system, environment, software, and hardware, or a combination of systems, environments, software, and hardware, as appropriate. For example, a system comprising a communications module, memory storing instructions and other required data, and at least one hardware processor interoperably coupled to the memory and the communications module can be used to execute process 300. In some implementations, the process 300 and related methods are executed by one or more components of the system 100 described above with respect to FIG. 1, such as the AI conversation system 102 and the customer AI models 132, and/or portions thereof. Further, it should be noted that process 300 does not necessarily proceed in a sequential manner, and elements of process 300 can happen repeatedly, in parallel or out of order as would be understood by one of ordinary skill in the art.

At 302, a call is initialized. During initialization a WebSocket or other communications protocol is opened which enables bidirectional communication between a user device and an AI conversation system (e.g., AI conversation system 102 of FIG. 1). In some implementations, the user initiates the call between the AI conversation system. In some implementations, e.g., based on prior conversation, the AI conversation system can initiate a call to the user. For example, the user may indicate interest in a particular topic, but that they don't have the time to delve into it at the moment. The AI conversation system can suggest “would you like me to call you back tomorrow?” to which the user can response “yes please call at four.” The following day at 4:00 μm in the user's time zone, the AI conversation system can initial a phone call with the user to continue the conversation. In some implementations, calls can be initiated by the AI conversation system in response to received texts, emails, or other triggers.

At 304, voice data or speech data is received from the user. In some implementations, the voice data is received in a PCM format, and is converted before being sent to a STT service for conversion to text.

At 306, the voice data is sent to the STT service and converted into text. In some examples, the STT service can provide both an interim text transcript, which is a low-latency stream of text, as well as a conclusive or endpoint transcript, which is a more accurate, but higher latency stream.

At 308, the text is received from the STT service. Natural language processing (NLP) can be performed on the received text, e.g., to monitor for completion of a caller's statement. In addition to NLP and semantic analysis, pauses in speaking, or punctuation marks in the transcript can be used to identify whether a caller has completed a statement that requires a response by the AI conversation system.

At 310, a determination is made as to whether the user has completed a query or thought. If they have not, process 300 returns to 308 and the system continues to listen and monitor for completeness. If it is determined that the user is completed, process 300 proceeds to 312.

It should be noted that 304 through 310 occur regardless of which other operations are happening in process 300. That is, even if a prompt is being generated (312) or speech is being streamed to the user device (340), if voice data is received from the user device 304 through 308 will occur concurrently with those other operations.

At 312, an AI model is selected for a response. The AI model can be selected based on parameters such as system latency, number of prompt tokens needed, complexity of the query, etc. Once an AI model is selected, or concurrently with selection of an AI model, a prompt is generated. The prompt is generated based on the received speech (e.g., the endpoint transcript) as well as additional external factors such as time of day, context of conversation, customer prompt customization etc. The generated prompt can also include contextual information, such as the current conversation history, and past conversation with the particular user.

At 314, during prompt generation, it is possible that the user will begin speaking again. For example, if the completeness determination at 310 was erroneous, more interim results from the STT service may be received. In this case, where the user interrupts prompt generation, process 300 proceeds to 316 and the prompt generation is canceled. Process 300 then returns to 308 where the AI conversation system continues to monitor for completion. If the prompt generation process is not interrupted, process 300 proceeds to 320.

It should be noted that 302 through 316 can be considered “listening operations.” That is, the system is listening to the user speaking during 302 through 316. Additionally, “listening operations” can occur in parallel with or simultaneously to “thinking operations” 320 through 332 and 348, as well as “speaking operations” 338 through 346.

At 320, the generated prompt is sent to the selected AI model, which receives the prompt and generates a stream of output tokens.

At 322, the output tokens are received by the AI conversation system. In some implementations the AI conversation system receives tokens from the AI model as embeddings, which are converted to text by the AI conversation system. In some implementations, the AI conversation system receives text directly from the AI model.

At 324, the stream of output tokens, or response, is parsed into sentences or phrases in order for conversion to speech or further processing. These phrases or sentences can be referred to as “chunks.” It should be noted that, while illustrates in one order, other sequences of operations are possible. For example, the response can be parsed after it is determined whether a function call is included (326 below).

At 326, after a chunk is received in the illustrated example, a determination is made whether it includes a function call from the AI model. If a function call is included in the output, process 300 proceeds to 328. Otherwise process 300 proceeds to 334.

At 328, the AI conversation system executes the function according to the function call. Executing the function can include querying additional systems for structured data, performing calculations, or other analysis.

At 330, the completion of the function results in a function return, which can be a set of structured data, the solution to an algorithm, or other result.

At 332, The function return is used to generate an updated prompt. In some implementations the updated prompt includes the previous prompt with the function return embedded or appended to it. Once the updated prompt is generated process 300 returns to 320

At 334, when the output from the AI model does not include any function calls, it is sent to a TTS service. In some implementations, prior to sending the output to the TTS service, a text optimization process can be performed on it. During text optimization, certain abbreviation can be replaced, and numbers be explicitly spelled out in order to avoid ambiguity or confusing speech results. For example, if the AI conversation system is being used in an automotive context, the term “350HP” may be replaced with “three hundred fifty horsepower.” Text optimization can be performed using pattern matching or other natural language processing techniques to identify certain key terms. In another example, addresses may be optimized i.e.: “2010 Main Rd, Davie, FL 33331” may be converted to “2010 Main Road, Davie, Florida 3 . . . 3 . . . 3 . . . 3 . . . 1” to ensure the zip code is spoken correctly. Whether to perform this text optimization can be determined using, for example, natural language processing, which can run optimization for the specific category of the prompt return. In this manner, industry specific jargon and other differences between text and speech can be identified and corrected prior to being sent to the TTS service.

At 336, the TTS service returns audio bytes associated with the AI model output. The audio bytes can be in many formats depending on the TTS service. For example, the audio bytes can be MP3 encoded audio with a variable bitrate that automatically adjusts based on network bandwidth. In some implementations, an initial phrase is used/sent first. This initial phrase can be a rapidly transcribed/converted portion of the response like “Okay!”, “Hmm . . . ”, or “Let me check” that can be rapidly sent. This initial response reduces the latency for the user between the end of their speech and the beginning of the AI conversational system's response.

At 338, the audio bytes are converted to a standardized format for use within the AI conversation system. For example, the audio bytes can be converted to a PCM format using a u-law algorithm. In some implementations the PCM format has a fixed sample rate of 8 Khz, which can then be used to determine a required playback time per bit. It should be noted that, when an output of process 300 is not a vocalization or speech, for example, an SMS is to be sent, or an email, then process 300 my optionally bypass 334, 336, and 338. Additionally, process 300 may perform 334 through 338 while simultaneously preparing other outputs (e.g., text message, email, etc.).

At 340, The converted audio is streamed to the user device at a predetermined bitrate that can be dynamically throttled based on network latency. This ensures that the user maintains the ability to interrupt the system without it talking over them. Because audio packets are only sent to the user device at a rate approximate to what it takes for them to play, a significant backlog of audio packets is not permitted to build up in the buffer of the client device, and thus the audio playback can be canceled rapidly.

At 342, during streaming of the audio to the user device, if the user interrupts by speaking, process 300 proceeds to 346. An interrupt can be detected by receipt of audio from the user device, or receipt of interim transcripts from the STT service. If the speech is not interrupted, process 300 continues to 344.

At 344, once the entirety of the AI output has been streamed to the user, the stream is completed and process 300 proceeds to 346.

At 346, regardless of whether the stream is complete (344) or was interrupted (342) no further packets are sent to the user device.

At 348, the AI output, as well as the prompts are stored in a repository associated with the user for future context and analytics.

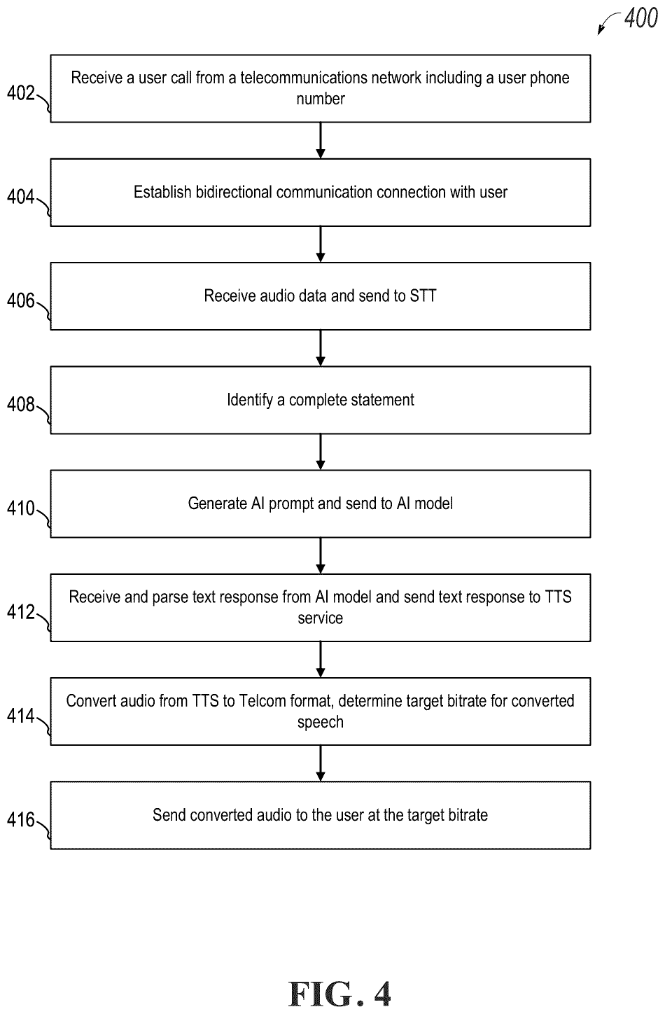

FIG. 4 is a flowchart showing an example process 400 for voice interaction with an AI model. It will be understood that process 400 and related methods may be performed, for example, by any suitable system, environment, software, and hardware, or a combination of systems, environments, software, and hardware, as appropriate. For example, a system comprising a communications module, memory storing instructions and other required data, and at least one hardware processor interoperably coupled to the memory and the communications module can be used to execute process 400. In some implementations, the process 300 and related methods are executed by one or more components of the system 100 described above with respect to FIG. 1, such as the AI conversation system 102 and the customer AI models 132, and/or portions thereof. Further, it should be noted that process 300 does not necessarily proceed in a sequential manner, and elements of process 400 can happen repeatedly, in parallel or out of order as would be understood by one of ordinary skill in the art.

At 402, a user call is received from a telecommunications network that includes a phone number. Additional information from the call can include geographic region, caller name, and other details. The telecommunications network can be a standard telephone network, or a voice over internet protocol (VOIP) network, among other things.

At 404, a bidirectional communication connection is established with the user. In some implementations this connection is a WebSocket connection. In general, the bidirectional communication connection enables full duplex communication. That is, the connection can support simultaneous transmission and receipt of audio data.

At 406, audio data is received via the bidirectional communication connection and sent to a speech to text (STT) service for transcription.

At 408, once a complete statement is identified based on the transcript, or timing of the received audio. In some implementations, the complete statement can be identified based on a semantic analysis or natural language processing of the received audio.

At 410, an AI prompt is generated based on the complete statement and sent to an AI model. The AI model can be a large language model, or other generative artificial intelligence model designed to receive a prompt and generate an output.

At 412, a text response is received from the AI model and parsed into phrases, sentences, or “chunks.” This parsed response can then be sent to a text-to-speech (TTS) service to convert the output into audio bytes.

At 414, the audio bytes received from the TTS service are converted into a format suitable for the telecommunications network. In some implementations, this is a PCM format. A target bitrate is determined for transmission of the converted audio to the user device. In some implementations this target bitrate is based on the latency between the user device and the AI conversation system, and is selected to ensure that a significant queue of audio packets is not sent to the user at a rate faster than the audio playback will be at the user device. This ensures the transmitted audio stream is interruptible.

At 416, the converted audio is sent to the user at the target bitrate.

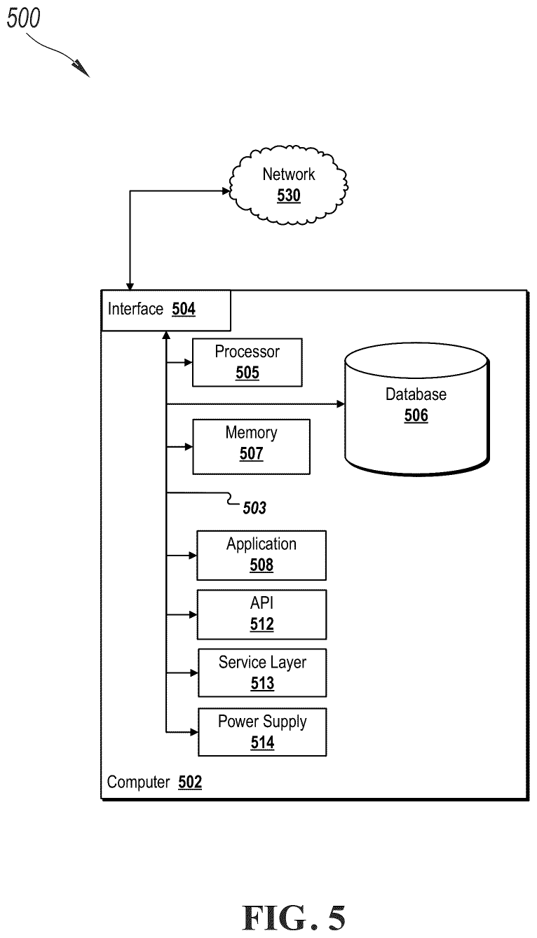

FIG. 5 is a block diagram illustrating an example of a computer-implemented system 500 used to provide computational functionalities associated with described algorithms, methods, functions, processes, flows, and procedures, according to an implementation of the present disclosure. In the illustrated implementation, system 500 includes a computer 502 and a network 530.

The illustrated computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 502 can include an input device, such as a keypad, keyboard, or touch screen, or a combination of input devices that can accept user information, and an output device that conveys information associated with the operation of the computer 502, including digital data, visual, audio, another type of information, or a combination of types of information, on a graphical-type user interface (UI) (or GUI) or other UI.

The computer 502 can serve in a role in a distributed computing system as, for example, a client, network component, a server, or a database or another persistency, or a combination of roles for performing the subject matter described in the present disclosure. The illustrated computer 502 is communicably coupled with a network 530. In some implementations, one or more components of the computer 502 can be configured to operate within an environment, or a combination of environments, including cloud-computing, local, or global.

At a high level, the computer 502 is an electronic computing device operable to receive, transmit, process, store, or manage data and information associated with the described subject matter. According to some implementations, the computer 502 can also include or be communicably coupled with a server, such as an application server, e-mail server, web server, caching server, or streaming data server, or a combination of servers.

The computer 502 can receive requests over network 530 (for example, from a client software application executing on another computer 502) and respond to the received requests by processing the received requests using a software application or a combination of software applications. In addition, requests can also be sent to the computer 502 from internal users (for example, from a command console or by another internal access method), external or third-parties, or other entities, individuals, systems, or computers.

Each of the components of the computer 502 can communicate using a system bus 503. In some implementations, any or all of the components of the computer 502, including hardware, software, or a combination of hardware and software, can interface over the system bus 503 using an application programming interface (API) 512, a service layer 513, or a combination of the API 512 and service layer 513. The API 512 can include specifications for routines, data structures, and object classes. The API 512 can be either computer-language independent or dependent and refer to a complete interface, a single function, or even a set of APIs. The service layer 513 provides software services to the computer 502 or other components (whether illustrated or not) that are communicably coupled to the computer 502. The functionality of the computer 502 can be accessible for all service consumers using the service layer 513. Software services, such as those provided by the service layer 513, provide reusable, defined functionalities through a defined interface. For example, the interface can be software written in a computing language (for example, JAVA or C++) or a combination of computing languages and providing data in a particular format (for example, extensible markup language (XML)) or a combination of formats. While illustrated as an integrated component of the computer 502, alternative implementations can illustrate the API 512 or the service layer 513 as stand-alone components in relation to other components of the computer 502 or other components (whether illustrated or not) that are communicably coupled to the computer 502. Moreover, any or all parts of the API 512 or the service layer 513 can be implemented as a child or a sub-module of another software module, enterprise application, or hardware module without departing from the scope of the present disclosure.

The computer 502 includes an interface 504. Although illustrated as a single interface 504, two or more interfaces 504 can be used according to particular needs, desires, or particular implementations of the computer 502. The interface 504 is used by the computer 502 for communicating with another computing system (whether illustrated or not) that is communicatively linked to the network 530 in a distributed environment. Generally, the interface 504 is operable to communicate with the network 530 and includes logic encoded in software, hardware, or a combination of software and hardware. More specifically, the interface 504 can include software supporting one or more communication protocols associated with communications such that the network 530 or hardware of interface 504 is operable to communicate physical signals within and outside of the illustrated computer 502.

The computer 502 includes a processor 505. Although illustrated as a single processor 505, two or more processors 505 can be used according to particular needs, desires, or particular implementations of the computer 502. Generally, the processor 505 executes instructions and manipulates data to perform the operations of the computer 502 and any algorithms, methods, functions, processes, flows, and procedures as described in the present disclosure.

The computer 502 also includes a database 506 that can hold data for the computer 502, another component communicatively linked to the network 530 (whether illustrated or not), or a combination of the computer 502 and another component. For example, database 506 can be an in-memory or conventional database storing data consistent with the present disclosure. In some implementations, database 506 can be a combination of two or more different database types (for example, a hybrid in-memory and conventional database) according to particular needs, desires, or particular implementations of the computer 502 and the described functionality. Although illustrated as a single database 506, two or more databases of similar or differing types can be used according to particular needs, desires, or particular implementations of the computer 502 and the described functionality. While database 506 is illustrated as an integral component of the computer 502, in alternative implementations, database 506 can be external to the computer 502. The database 506 can hold any data type necessary for the described solution.

The computer 502 also includes a memory 507 that can hold data for the computer 502, another component or components communicatively linked to the network 530 (whether illustrated or not), or a combination of the computer 502 and another component. Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507, two or more memories 507 or similar or differing types can be used according to particular needs, desires, or particular implementations of the computer 502 and the described functionality. While memory 507 is illustrated as an integral component of the computer 502, in alternative implementations, memory 507 can be external to the computer 502.

The application 508 is an algorithmic software engine providing functionality according to particular needs, desires, or particular implementations of the computer 502, particularly with respect to functionality described in the present disclosure. For example, application 508 can serve as one or more components, modules, or applications. Further, although illustrated as a single application 508, the application 508 can be implemented as multiple applications 508 on the computer 502. In addition, although illustrated as integral to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion or management circuits (including recharging, standby, or another power management functionality). In some implementations, the power supply 514 can include a power plug to allow the computer 502 to be plugged into a wall socket or another power source to, for example, power the computer 502 or recharge a rechargeable battery.

There can be any number of computers 502 associated with, or external to, a computer system containing computer 502, each computer 502 communicating over network 530. Further, the term “client,” “user,” or other appropriate terminology can be used interchangeably, as appropriate, without departing from the scope of the present disclosure. Moreover, the present disclosure contemplates that many users can use one computer 502, or that one user can use multiple computers 502.

In view of the above described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A method comprising: establishing a user call on a telecommunications network, the user call comprising a user phone number; establishing a bidirectional communication connection with the user on a telecommunications network; receiving audio data from the user and sending the audio data to a speech to text (STT) service; receiving, from the STT service, text data representing the audio data; identifying, within the text data, a complete statement of the user; generating an AI prompt based on the complete statement and sending the AI prompt to an AI model; receiving a text response from the AI model; parsing the text response into one or more response statements; sending the one or more response statements to a text to speech (TTS) service; receiving a stream of speech data from the TTS service; converting the speech data to a format suitable for the telecommunications network; determining a target bitrate for the converted speech data; and sending the converted speech data to the user at the target bitrate.

Example 2. The method of example 1, wherein the bidirectional communication connection is a WebSocket connection.

Example 3. The method of any of examples 1 or 2, comprising: prior to identifying the complete statement of the user, sending an initialization prompt to the AI model, the initialization prompt providing the AI model with a context of the conversation.

Example 4. The method of example 3, wherein the initialization prompt is based on the user phone number.

Example 5. The method of example 4, wherein the initialization prompt comprises previous conversation history associated with the user.

Example 6. The method of any of the previous examples, comprising: prior to identifying the complete statement of the user, sending a predetermined opening statement to the user.

Example 7. The method of any of the previous examples, wherein the text data representing the audio data includes punctuation, and wherein the punctuation is used to identify the complete statement of the user.

Example 8. The method of any of the previous examples, wherein generating the AI prompt comprises appending a conversation history associated with the user to the complete statement.

Example 9. The method of example 8, wherein generating the AI prompt comprises appending a context prompt to the complete statement, wherein the context prompt provides the AI model with instructions defining a desired response.

Example 10. The method of any of the previous examples, wherein parsing the text response comprises identifying a function call within the text response; executing the function call; receiving a function return; generating an updated prompt comprising the function return; and sending the updated prompt to the AI model.

Example 11. The method of example 10, wherein executing the function call comprises transmitting a request for data to an external system, and wherein the function return comprises structured data from the external system.

Example 12. The method of any of the previous examples, wherein the format suitable for the telecommunications network is a PCM format generated using a u-law algorithm.

Example 13. The method of any of the previous examples, wherein the target bitrate is determined based on a maximum allowable delay minus a communication latency.

Example 14. The method of any of the previous examples, wherein the prompt and the response statement are stored in a repository associated with the user.

Example 15. A non-transitory, computer-readable medium storing one or more instructions executable by a computer system to perform operations comprising: establishing a user call on a telecommunications network, the user call comprising a user phone number; establishing a bidirectional communication connection with the user; receiving audio data from the user and sending the audio data to a speech to text (STT) service; receiving, from the STT service, text data representing the audio data; identifying, within the text data, a complete statement of the user; generating an AI prompt based on the complete statement and sending the AI prompt to an AI model; receiving a text response from the AI model; parsing the text response into one or more response statements; sending the one or more response statements to a text to speech (TTS) service; receiving a stream of speech data from the TTS service; converting the speech data to a format suitable for the telecommunications network; determining a target bitrate for the converted speech data; and sending the converted speech data to the user at the target bitrate.

Example 16. The medium of example 15, wherein the bidirectional communication connection is a WebSocket connection.

Example 17. The medium of any one of examples 15 or 16, the operations comprising: prior to identifying the complete statement of the user, sending an initialization prompt to the AI model, the initialization prompt providing the AI model with a context of the conversation.

Example 18. The medium of example 17, wherein the initialization prompt is based on the user phone number.

Example 19. The medium of example 18, wherein the initialization prompt comprises previous conversation history associated with the user.

Example 20. The medium of any one of examples 15 through 19, comprising: prior to identifying the complete statement of the user, sending a predetermined opening statement to the user.

Example 21. The medium of any one of examples 15 through 20, wherein the text data representing the audio data includes punctuation, and wherein the punctuation is used to identify the complete statement of the user.

Example 22. The medium of any one of examples 15 through 21, wherein generating the AI prompt comprises appending a conversation history associated with the user to the complete statement.

Example 23. The medium of example 22, wherein generating the AI prompt comprises appending a context prompt to the complete statement, wherein the context prompt provides the AI model with instructions defining a desired response.

Example 24. The medium of any one of examples 15 through 23, wherein parsing the text response comprises identifying a function call within the text response; executing the function call; receiving a function return; generating an updated prompt comprising the function return; and sending the updated prompt to the AI model.

Example 25. The medium of example 24, wherein executing the function call comprises transmitting a request for data to an external system, and wherein the function return comprises structured data from the external system.

Example 26. The medium of any one of examples 15 through 25, wherein the format suitable for the telecommunications network is a PCM format generated using a u-law algorithm.

Example 27. The medium of any one of examples 15 through 26, wherein the target bitrate is determined based on a maximum allowable delay minus a communication latency.

Example 28. The medium of any one of examples 15 through 27, wherein the prompt and the response statement are stored in a repository associated with the user.

Example 29. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: establishing a user call on a telecommunications network, the user call comprising a user phone number; establishing a bidirectional communication connection with the user; receiving audio data from the user and sending the audio data to a speech to text (STT) service; receiving, from the STT service, text data representing the audio data; identifying, within the text data, a complete statement of the user; generating an AI prompt based on the complete statement and sending the AI prompt to an AI model; receiving a text response from the AI model; parsing the text response into one or more response statements; sending the one or more response statements to a text to speech (TTS) service; receiving a stream of speech data from the TTS service; converting the speech data to a format suitable for the telecommunications network; determining a target bitrate for the converted speech data; and sending the converted speech data to the user at the target bitrate.

Example 30. The system of example 29, wherein the bidirectional communication connection is a WebSocket connection.

Example 31. The system of example 29 or 30, the operations comprising: prior to identifying the complete statement of the user, sending an initialization prompt to the AI model, the initialization prompt providing the AI model with a context of the conversation.

Example 32. The system of example 31, wherein the initialization prompt is based on the user phone number.

Example 33. The system of example 32, wherein the initialization prompt comprises previous conversation history associated with the user.

Example 34. The system of any of examples 29 through 33, the operations comprising: prior to identifying the complete statement of the user, sending a predetermined opening statement to the user.

Example 35. The system of any of examples 29 through 34, wherein the text data representing the audio data includes punctuation, and wherein the punctuation is used to identify the complete statement of the user.

Example 36. The system of any of examples 29 through 35, wherein generating the AI prompt comprises appending a conversation history associated with the user to the complete statement.

Example 37. The system of example 36, wherein generating the AI prompt comprises appending a context prompt to the complete statement, wherein the context prompt provides the AI model with instructions defining a desired response.

Example 38. The system of any of examples 29 through 37, wherein parsing the text response comprises identifying a function call within the text response; executing the function call; receiving a function return; generating an updated prompt comprising the function return; and sending the updated prompt to the AI model.

Example 39. The system of example 38, wherein executing the function call comprises transmitting a request for data to an external system, and wherein the function return comprises structured data from the external system.

Example 40. The system of any of examples 29 through 39, wherein the format suitable for the telecommunications network is a PCM format generated using a u-law algorithm.

Example 41. The system of any of examples 29 through 40, wherein the target bitrate is determined based on a maximum allowable delay minus a communication latency.

Example 42. The system of any of examples 29 through 41, wherein the prompt and the response statement are stored in a repository associated with the user.

Example 43. A method comprising: establishing a user call on a telecommunications network, the user call comprising a user phone number; receiving audio data from the user and sending the audio data to a speech to text (STT) service; receiving, from the STT service, text data representing the audio data; identifying, based on the text data, a presumed complete statement of the user; initiating generation of an AI prompt based on the presumed complete statement; during generation, receiving additional text data indicating that the presumed complete statement of the user was not a complete statement; and canceling generation of the AI prompt.

Example 44. The method of example 43, wherein the text data comprises interim STT results and conclusive STT results, wherein the interim STT results are streamed at a reduced latency compared to conclusive STT results, and wherein conclusive STT results represent a processing of longer durations of speech.

Example 45. The method of example 44, wherein the additional text data comprises additional interim STT results.

Example 46. The method of any of examples 43 through 45 comprising: receiving second text data comprising a second conclusive result; and initiating generation of an updated AI prompt based on the second text data.

Example 47. The method of any of examples 43 through 46, comprising establishing a bidirectional communication connection with the user, wherein the bidirectional communication connection is a WebSocket connection.

Example 48. The method of any of examples 43 through 47, comprising: prior to identifying the presumed complete statement of the user, sending an initialization prompt to an AI model, the initialization prompt providing the AI model with a conversation context.

Example 49. The method of example 48, wherein the initialization prompt is based on the user phone number.

Example 50. The method of example 49, wherein the initialization prompt comprises previous conversation history associated with the user.

Example 51. The method of any of examples 43 through 450, wherein the text data representing the audio data includes punctuation, and wherein the punctuation is used to identify the complete statement of the user.

Example 52. A non-transitory, computer-readable medium storing one or more instructions executable by a computer system to perform operations comprising: establishing a user call on a telecommunications network, the user call comprising a user phone number; receiving audio data from the user and sending the audio data to a speech to text (STT) service; receiving, from the STT service, text data representing the audio data; identifying, based on the text data, a presumed complete statement of the user; initiating generation of an AI prompt based on the presumed complete statement; during generation, receiving additional text data indicating that the presumed complete statement of the user was not a complete statement; and canceling generation of the AI prompt.

Example 53. The medium of example 52, wherein the text data comprises interim STT results and conclusive STT results, wherein the interim STT results are streamed at a reduced latency compared to conclusive STT results, and wherein conclusive STT results represent a processing of longer durations of speech.

Example 54. The medium of example 53, wherein the additional text data comprises additional interim STT results.

Example 55. The medium of any of examples 52 through 54, the operations comprising: receiving second text data comprising a second conclusive result; and initiating generation of an updated AI prompt based on the second text data.

Example 56. The medium of any of examples 52 through 55, the operations comprising establishing a bidirectional communication connection with the user, wherein the bidirectional communication connection is a WebSocket connection.

Example 57. The medium of any of examples 52 through 56, the operations comprising: prior to identifying the presumed complete statement of the user, sending an initialization prompt to an AI model, the initialization prompt providing the AI model with a conversation context.

Example 58. The medium of example 57, wherein the initialization prompt is based on the user phone number.

Example 59. The medium of example 58, wherein the initialization prompt comprises previous conversation history associated with the user.

Example 60. The medium of any of examples 52 through 59, wherein the text data representing the audio data includes punctuation, and wherein the punctuation is used to identify the complete statement of the user.

Example 61. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: establishing a user call on a telecommunications network, the user call comprising a user phone number; receiving audio data from the user and sending the audio data to a speech to text (STT) service; receiving, from the STT service, text data representing the audio data; identifying, based on the text data, a presumed complete statement of the user; initiating generation of an AI prompt based on the presumed complete statement; during generation, receiving additional text data indicating that the presumed complete statement of the user was not a complete statement; and canceling generation of the AI prompt.

Example 62. The system of example 61, wherein the text data comprises interim STT results and conclusive STT results, wherein the interim STT results are streamed at a reduced latency compared to conclusive STT results, and wherein conclusive STT results represent a processing of longer durations of speech.

Example 63. The system of examples 62 or 63, wherein the additional text data comprises additional interim STT results.

Example 64. The system of any of examples 61 through 63, the operations comprising: receiving second text data comprising a second conclusive result; and initiating generation of an updated AI prompt based on the second text data.

Example 65. The system of any of examples 61 through 64, comprising establishing a bidirectional communication connection with the user, wherein the bidirectional communication connection is a WebSocket connection.

Example 66. The system of any of examples 61 through 65, the operations comprising: prior to identifying the presumed complete statement of the user, sending an initialization prompt to an AI model, the initialization prompt providing the AI model with a conversation context.

Example 67. The system of example 66, wherein the initialization prompt is based on the user phone number.

Example 68. The system of example 67, wherein the initialization prompt comprises previous conversation history associated with the user.

Example 69. A method comprising: receiving a text response from an AI model; parsing the text response into one or more response statements; sending the one or more response statements to a text to speech (TTS) service; receiving a stream of speech data from the TTS service; determining a target bitrate for the speech data; sending the speech data to a user device at the target bitrate; during sending the speech data receiving audio data from a user and in response: ceasing sending the speech data; sending the audio data to a STT service to receive text data; and generating an updated AI prompt based on the text data and sending the updated AI prompt to the AI model.

Example 70. The method of example 69, comprising prior to receiving the text response from the AI model: establishing a user call on a telecommunications network, the user call comprising a user phone number; establishing a bidirectional communication connection with the user; receiving initial audio data from the user and sending the initial audio data to the speech to text (STT) service; receiving, from the STT service, initial text data representing the initial audio data; and generating an AI prompt based on the initial text data and sending the AI prompt to the AI model.

Example 71. The method of example 70, wherein the bidirectional communication connection is a WebSocket connection.

Example 72. The method any of examples 69 through 71, comprising: converting the speech data to a format suitable for a telecommunications network.

Example 73. The method of example 72, wherein the format suitable for the telecommunications network is a PCM format generated using a u-law algorithm.

Example 74. The method of any of examples 69 through 73, wherein generating the updated AI prompt comprises appending a conversation history associated with the user to AI prompt.

Example 75. The method of any of examples 69 through 74, wherein parsing the text response comprises identifying a function call within the text response; executing the function call; receiving a function return; generating an updated prompt comprising the function return; and sending the updated prompt to the AI model.

Example 76. The method of example 75, wherein executing the function call comprises transmitting a request for data to an external system, and wherein the function return comprises structured data from the external system.

Example 77. The method of any of examples 69 through 76, wherein the target bitrate is determined based on a maximum allowable delay minus a communication latency.

Example 78. A non-transitory, computer-readable medium storing one or more instructions executable by a computer system to perform operations comprising: receiving a text response from an AI model; parsing the text response into one or more response statements; sending the one or more response statements to a text to speech (TTS) service; receiving a stream of speech data from the TTS service; determining a target bitrate for the speech data; sending the speech data to a user device at the target bitrate; during sending the speech data receiving audio data from a user and in response: ceasing sending the speech data; sending the audio data to a STT service to receive text data; and generating an updated AI prompt based on the text data and sending the updated AI prompt to the AI model.

Example 79. The medium of example 78, the operations comprising prior to receiving the text response from the AI model: establishing a user call on a telecommunications network, the user call comprising a user phone number; establishing a bidirectional communication connection with the user; receiving initial audio data from the user and sending the initial audio data to the speech to text (STT) service; receiving, from the STT service, initial text data representing the initial audio data; and generating an AI prompt based on the initial text data and sending the AI prompt to the AI model.

Example 80. The medium of example 79, wherein the bidirectional communication connection is a WebSocket connection.

Example 81. The medium of any of examples 78 through 80, the operations comprising: converting the speech data to a format suitable for a telecommunications network.

Example 82. The medium of example 81, wherein the format suitable for the telecommunications network is a PCM format generated using a u-law algorithm.

Example 83. The medium of any of examples 78 through 82, wherein generating the updated AI prompt comprises appending a conversation history associated with the user to the AI prompt.

Example 84. The medium of any of examples 78 through 83, wherein parsing the text response comprises identifying a function call within the text response; executing the function call; receiving a function return; generating an updated prompt comprising the function return; and sending the updated prompt to the AI model.

Example 85. The medium of example 84, wherein executing the function call comprises transmitting a request for data to an external system, and wherein the function return comprises structured data from the external system.

Example 86. The medium of any of examples 78 through 85, wherein the target bitrate is determined based on a maximum allowable delay minus a communication latency.

Example 87. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving a text response from an AI model; parsing the text response into one or more response statements; sending the one or more response statements to a text to speech (TTS) service; receiving a stream of speech data from the TTS service; determining a target bitrate for the speech data; sending the speech data to a user device at the target bitrate; during sending the speech data receiving audio data from a user and in response: ceasing sending the speech data; sending the audio data to a STT service to receive text data; and generating an updated AI prompt based on the text data and sending the updated AI prompt to the AI model.

Example 88. The system of example 87, the operations comprising prior to receiving the text response from the AI model: establishing a user call on a telecommunications network, the user call comprising a user phone number; establishing a bidirectional communication connection with the user; receiving initial audio data from the user and sending the initial audio data to the speech to text (STT) service; receiving, from the STT service, initial text data representing the initial audio data; and generating an AI prompt based on the initial text data and sending the AI prompt to the AI model.

Example 89. The system of example 88, wherein the bidirectional communication connection is a WebSocket connection.

Example 90. The system of any one of examples 87 through 89, the operations comprising: converting the speech data to a format suitable for a telecommunications network.

Example 91. The system of example 90, wherein the format suitable for the telecommunications network is a PCM format generated using a u-law algorithm.

Example 92. The system of any one of examples 87 through 91, wherein generating the updated AI prompt comprises appending a conversation history associated with the user to the AI prompt.

Example 93. The system of any one of examples 87 through 92, wherein parsing the text response comprises identifying a function call within the text response; executing the function call; receiving a function return; generating an updated prompt comprising the function return; and sending the updated prompt to the AI model.

Example 94. The system of example 93, wherein executing the function call comprises transmitting a request for data to an external system, and wherein the function return comprises structured data from the external system.

Example 95. The system of any one of examples 87 through 94, wherein the target bitrate is determined based on a maximum allowable delay minus a communication latency.

Example 96. A method comprising: receiving a text response from an AI model, the text response based on an input prompt that was previously sent to the AI model; dividing received portions of the text response based on punctuation into response chunks; sending each response chunk to a text to speech (TTS) service; receiving a stream of speech data from the TTS service; determining a target bitrate for the speech data; and sending the speech data to a user device at the target bitrate.

Example 97. The method of example 96, wherein dividing the received portions of the text response occurs concurrently with receiving the text response.

Example 98. A non-transitory, computer-readable medium storing one or more instructions executable by a computer system to perform operations comprising: receiving a text response from an AI model, the text response based on an input prompt that was previously sent to the AI model; dividing received portions of the text response based on punctuation into response chunks; sending each response chunk to a text to speech (TTS) service; receiving a stream of speech data from the TTS service; determining a target bitrate for the speech data; and sending the speech data to a user device at the target bitrate.

Example 99. The medium of example 98, wherein dividing the received portions of the text response occurs concurrently with receiving the text response.

Example 100. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving a text response from an AI model, the text response based on an input prompt that was previously sent to the AI model; dividing received portions of the text response based on punctuation into response chunks; sending each response chunk to a text to speech (TTS) service; receiving a stream of speech data from the TTS service; determining a target bitrate for the speech data; and sending the speech data to a user device at the target bitrate.

Example 101. The system of example 100, wherein dividing the received portions of the text response occurs concurrently with receiving the text response.

Example 102. A method comprising: receiving a text response from an AI model, the text response based on an input prompt that was previously sent to the AI model; dividing received portions of the text response based on punctuation into response chunks; and sending each response chunk to a text to speech (TTS) service.

Example 103. The method of example 102, wherein dividing the received portions of the text response occurs concurrently with receiving the text response.

Example 104. A non-transitory, computer-readable medium storing one or more instructions executable by a computer system to perform operations comprising: receiving a text response from an AI model, the text response based on an input prompt that was previously sent to the AI model; dividing received portions of the text response based on punctuation into response chunks; and sending each response chunk to a text to speech (TTS) service.

Example 105. The medium of example 104, wherein dividing the received portions of the text response occurs concurrently with receiving the text response.

Example 106. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving a text response from an AI model, the text response based on an input prompt that was previously sent to the AI model; dividing received portions of the text response based on punctuation into response chunks; and sending each response chunk to a text to speech (TTS) service.

Example 107. The system of example 106, wherein dividing the received portions of the text response occurs concurrently with receiving the text response.

Example 108. A method comprising: receiving, from a speech to text (STT) service, text data representing voice data; identifying, within the text data, a complete statement of a user; generating an AI prompt based on the complete statement and sending the AI prompt to an AI model, wherein the AI prompt comprises: a system prompt providing the AI model with context and desired behavior; a user prompt comprising the text data; and a conversation history associated with previous prompts and responses.

Example 109. The method of example 108, comprising: in response to sending the AI prompt, receiving a text response from the AI model, the text response comprising a function call; executing the function call; receiving a function return; generating an updated prompt comprising the function return; and sending the updated prompt to the AI model.

Example 110. The method of example 109, wherein executing the function call comprises transmitting a request for data to an external system, and wherein the function return comprises structured data from the external system.

Example 111. A non-transitory, computer-readable medium storing one or more instructions executable by a computer system to perform operations comprising: receiving, from a speech to text (STT) service, text data representing voice data; identifying, within the text data, a complete statement of a user; generating an AI prompt based on the complete statement and sending the AI prompt to an AI model, wherein the AI prompt comprises: a system prompt providing the AI model with context and desired behavior; a user prompt comprising the text data; and a conversation history associated with previous prompts and responses.

Example 112. The medium of example 111, comprising: in response to sending the AI prompt, receiving a text response from the AI model, the text response comprising a function call; executing the function call; receiving a function return; generating an updated prompt comprising the function return; and sending the updated prompt to the AI model.

Example 113. The medium of example 112, wherein executing the function call comprises transmitting a request for data to an external system, and wherein the function return comprises structured data from the external system.

Example 114. A computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving, from a speech to text (STT) service, text data representing voice data; identifying, within the text data, a complete statement of a user; generating an AI prompt based on the complete statement and sending the AI prompt to an AI model, wherein the AI prompt comprises: a system prompt providing the AI model with context and desired behavior; a user prompt comprising the text data; and a conversation history associated with previous prompts and responses.

Example 115. The system of example 114, comprising: in response to sending the AI prompt, receiving a text response from the AI model, the text response comprising a function call; executing the function call; receiving a function return; generating an updated prompt comprising the function return; and sending the updated prompt to the AI model.

Example 116. The system of example 115, wherein executing the function call comprises transmitting a request for data to an external system, and wherein the function return comprises structured data from the external system.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method comprising:
establishing a user call on a telecommunications network, the user call comprising a user phone number;
establishing a bidirectional communication connection with the user on a telecommunications network;
receiving audio data from the user and sending the audio data to a speech to text (STT) service;
receiving, from the STT service, text data representing the audio data;
identifying, within the text data, a complete statement of the user;
generating an AI prompt based on the complete statement and sending the AI prompt to an AI model;
receiving a text response from the AI model;
parsing the text response into one or more response statements;
sending the one or more response statements to a text to speech (TTS) service;
receiving a stream of speech data from the TTS service;
converting the speech data to a format suitable for the telecommunications network;
determining a target bitrate for the converted speech data; and
sending the converted speech data to the user at the target bitrate.

2. The method of claim 1, wherein the bidirectional communication connection is a WebSocket connection.

3. The method of claim 1, comprising:
prior to identifying the complete statement of the user, sending an initialization prompt to the AI model, the initialization prompt providing the AI model with a context of the conversation.

4. The method of claim 3, wherein the initialization prompt is based on the user phone number, and wherein the initialization prompt comprises previous conversation history associated with the user.

5. The method of claim 1, comprising:
prior to identifying the complete statement of the user, sending a predetermined opening statement to the user.

6. The method of claim 1, wherein the text data representing the audio data includes punctuation, and wherein the punctuation is used to identify the complete statement of the user.

7. The method of claim 1, wherein generating the AI prompt comprises appending a conversation history associated with the user to the complete statement, and wherein generating the AI prompt comprises appending a context prompt to the complete statement, wherein the context prompt provides the AI model with instructions defining a desired response.

8. The method of claim 1, wherein parsing the text response comprises identifying a function call within the text response;
executing the function call;
receiving a function return;
generating an updated prompt comprising the function return; and
sending the updated prompt to the AI model.

9. The method of claim 8, wherein executing the function call comprises transmitting a request for data to an external system, and wherein the function return comprises structured data from the external system.

10. The method of claim 1, wherein the format suitable for the telecommunications network is a PCM format generated using a u-law algorithm, and wherein the target bitrate is determined based on a maximum allowable delay minus a communication latency.

11. The method of claim 1, wherein the prompt and the response statement are stored in a repository associated with the user.

12. A non-transitory, computer-readable medium storing one or more instructions executable by a computer system to perform operations comprising:
establishing a user call on a telecommunications network, the user call comprising a user phone number;
establishing a bidirectional communication connection with the user on a telecommunications network;
receiving audio data from the user and sending the audio data to a speech to text (STT) service;
receiving, from the STT service, text data representing the audio data;
identifying, within the text data, a complete statement of the user;
generating an AI prompt based on the complete statement and sending the AI prompt to an AI model;
receiving a text response from the AI model;
parsing the text response into one or more response statements;
sending the one or more response statements to a text to speech (TTS) service;
receiving a stream of speech data from the TTS service;
converting the speech data to a format suitable for the telecommunications network;
determining a target bitrate for the converted speech data; and
sending the converted speech data to the user at the target bitrate.

13. The medium of claim 12, wherein the bidirectional communication connection is a WebSocket connection.

14. The medium of claim 12, the operations comprising:
prior to identifying the complete statement of the user, sending an initialization prompt to the AI model, the initialization prompt providing the AI model with a context of the conversation.

15. The medium of claim 14, wherein the initialization prompt is based on the user phone number, and wherein the initialization prompt comprises previous conversation history associated with the user.

16. The medium of claim 12, the operations comprising:
prior to identifying the complete statement of the user, sending a predetermined opening statement to the user.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
establishing a user call on a telecommunications network, the user call comprising a user phone number;
establishing a bidirectional communication connection with the user on a telecommunications network;
receiving audio data from the user and sending the audio data to a speech to text (STT) service;
receiving, from the STT service, text data representing the audio data;
identifying, within the text data, a complete statement of the user;
generating an AI prompt based on the complete statement and sending the AI prompt to an AI model;
receiving a text response from the AI model;
parsing the text response into one or more response statements;
sending the one or more response statements to a text to speech (TTS) service;
receiving a stream of speech data from the TTS service;
converting the speech data to a format suitable for the telecommunications network;
determining a target bitrate for the converted speech data; and
sending the converted speech data to the user at the target bitrate.

18. The system of claim 12, wherein the bidirectional communication connection is a WebSocket connection.

19. The system of claim 12, the operations comprising:
prior to identifying the complete statement of the user, sending an initialization prompt to the AI model, the initialization prompt providing the AI model with a context of the conversation.

20. The system of claim 19, wherein the initialization prompt is based on the user phone number, and wherein the initialization prompt comprises previous conversation history associated with the user.
